(19) United States
(12) Patent Application Publication
(10) Pub. No.: US 2025/0326572 A1
(43) Pub. Date: Oct. 23, 2025

(54) APPARATUS AND METHOD OF SEPARATING WASTE

(71) Applicants: Elias YAMINE, Tulsa, OK (US); Alexander YAMINE, Tulsa, OK (US)

(72) Inventors: Elias YAMINE, Tulsa, OK (US); Alexander YAMINE, Tulsa, OK (US)

(21) Appl. No.: 18/868,236

(22) PCT Filed: May 25, 2022
(86) PCT No.: PCT/US2022/030870

§ 371 Date: Nov. 22, 2024

(51) Int. Cl. B65F 1/00; B65G 47/46

(52) U.S. Cl. CPC B65F 1/0053; B65G 47/46; B65F 2001/008; B65F 2210/138; B65F 2210/176

(57) ABSTRACT

A mechanical rotational device located at the base of a gravity waste chute which efficiently separates homogeneous and/or heterogeneous waste into waste receptacles. The device includes a mechanical rotational diversion mechanism which utilizes an electromechanical rotation element affixed to a base used to rotate and divert homogeneous and/or heterogeneous waste into designated respective waste receptacles.

### TECHNICAL FIELD

This description relates generally to waste management and recycling, but more particularly to non-limiting embodiments of a rotational mechanical device located at the base of a gravity waste chute, which efficiently separates discarded recyclable waste to sort homogeneous and/or heterogeneous waste into respective containers, such as recyclable waste containers.

### BACKGROUND

Recycling of recyclable waste is the process of collecting, sorting and processing recyclable waste that would otherwise be thrown away as trash and turning the recyclable waste into new products using the recycled raw materials. A problem lies in the initial separation of the recyclable waste into homogeneous genres in a corresponding receptacle, such as plastic in a receptacle for plastic, paper in a receptacle for paper, metal in a receptacle for metal, and glass in a receptacle for glass. In the past, gravity chutes have had only one bin located at the base of the discharge point of the chute where the heterogeneous waste is deposited and all waste is sent to a trash collection center where it is manually separated, which takes long man hours and has elevated costs, thereby making recycling an expensive option.

There are other waste separation devices for garbage chutes which only offer one or two possible separation points, which utilize actuators and flaps that divert the waste to a different path. However this method is limited due to several factors. First, the actuators push and pull a lever arm causing premature failure and low Mean Time Between Failure (MTBF) due to the stress of impact the waste materials have on the diversion surfaces. As the waste falls through the gravity chute, it picks up speed and momentum and when the waste reaches the base of the chute, there is a forcible impact on the diversion surface. Second, the actuators' speed of movement is slow to react, causing delay times on the floor in use to allow access to the discharge portal.

Therefore, there is a need for a better way to provide gravity chutes with the ability to separate discarded waste materials utilizing a rotational diversion surface which is unaffected by the deflecting impact of waste materials and which reduces delay times.

### SUMMARY

Illustrative, non-limiting embodiments of the present disclosure address the above disadvantages and other disadvantages not described above. Also, a non-limiting embodiment is not required to overcome the disadvantages described above, and an illustrative, non-limiting embodiment may not overcome any of the problems described above.

Aspects of one or more non-limiting embodiments provide a horizontal rotational angled impact diversion surface residing in a horizontal rotational housing, which acts as a mechanical diversion device which evenly disperses the waste deposit impact energy over a wider surface area, thereby reducing stress on the angled impact diversion surface horizontal rotational mechanical hardware.

According to one aspect of one or more non-limiting embodiments, the diverter is made of stainless steel or other hard materials which resist corrosion and have a long lifespan due to the change in impact energy placed upon the impact surface compared to conventional wiper actuated diversion plates where the impact energy is put solely on the swivel ball mount causing premature failure and heavy maintenance for multi-annual repair.

According to one aspect of one or more non-limiting embodiments, the rotational mechanical device is controlled by a central controller/electronic sorting controller, which receives information from a user selection on a user interface. The user interface may be located on floors above the rotational mechanical sorting device. The user interface sends sufficient signals to the central controller, which relays user selection formatted information to the rotational controller which controls the rotational relationship corresponding to the user's selection.

An aspect of a non-limiting embodiment requires less maintenance due to the stresses being removed from swivel ball joints on the actuator arms/hinges and being replaced with a rotational transfer impact surface housed in a rotational housing resting on a plurality of evenly placed bearing arrays designed to handle downward forced impacts.

Additional non-limiting embodiments will be set forth in the description that follows and, in part, will be apparent from the description, and/or may be learned by practice of the presented non-limiting embodiments of the disclosure.

### BRIEF DESCRIPTION OF DRAWINGS

Features, advantages, and significance of non-limiting embodiments of the disclosure will be described below with reference to the accompanying drawings, in which like signs denote like elements, and wherein:

FIG. 1 is a diagram of a gravity chute according to a non-limiting embodiment;

FIG. 2 is a front and side view of an angled impact diversion surface residing in a housing which rests on transfer bearings, according to a non-limiting embodiment;

FIG. 3 is a diagram showing a non-limiting embodiment wherein an angled impact diversion surface is being struck by a discarded waste container, and showing a diversion surface housing, a diversion surface housing crown and a lower crown diversion surface;

FIG. 4 is a diagram showing a side view of the angled impact diversion surface surface, according to a non-limiting embodiment, wherein the angled impact diversion surface diverts discarded waste material into a lower waste receptacle located to the front of a diversion rotating device according to the waste material's genre selected by the first user;

FIG. 5 shows a side view, according to a non-limiting embodiment, with a 90 degree rotated angled impact diversion surface diverting discarded waste material over the lower crown diversion shield signified by a rotational icon showing movement from the original angled impact diversion surface position in FIG. 4;

FIG. 6 shows a side view, according to a non-limiting embodiment, with a 45 degree rotation depicting front and side rotation surfaces;

FIG. 7 is a rotational positional diagram showing rotation positions of the angled impact diversion surface which diverts the discarded waste material to waste receptacles in four positions, according to a non-limiting embodiment;

FIG. 8 is a block diagram of example components of a user interface according to a non-limiting embodiment;

FIG. 9 is a block diagram showing a user interface, central controller/sorting controller and a rotational controller according to a non-limiting embodiment; and

FIG. 10 is a flow chart showing a method of horizontal rotational separation of waste according to a non-limiting embodiment.

### DETAILED DESCRIPTION

The following detailed description of example non-limiting embodiments refers to the accompanying drawings. The same reference numbers in different drawings may identify the same or similar elements.

The matters defined in the description, such as detailed construction and elements, are provided to assist in a comprehensive understanding of the example embodiments. However, it is apparent that the example non-limiting embodiments can be practiced without those specifically defined matters. Also, well-known functions or constructions are not described in detail since they would obscure the description with unnecessary detail.

The description provides illustration, but is not intended to be exhaustive or to limit the implementations to the precise form disclosed. Modifications and variations are possible in light of the disclosure or may be acquired from practice of the implementations. Further, one or more features or components of one embodiment may be incorporated into or combined with another embodiment (or one or more features of another embodiment). Additionally, in the flowcharts and descriptions of operations provided below, it is understood that one or more operations may be omitted, one or more operations may be added, one or more operations may be performed simultaneously (at least in part), and the order of one or more operations may be switched.

It will be apparent that systems and/or methods, described herein, may be implemented in different forms of hardware, firmware, or a combination of hardware and software. The actual specialized control hardware or software code used to implement these systems and/or methods is not limiting of the implementations. Thus, the operation and behavior of the systems and/or methods are described herein without reference to specific software code. It is understood that software and hardware may be designed to implement the systems and/or methods based on the description herein.

Even though particular combinations of features are recited in the claims and/or disclosed in the specification, these combinations are not intended to limit the disclosure of possible implementations. In fact, many of these features may be combined in ways not specifically recited in the claims and/or disclosed in the specification. Although each dependent claim listed below may directly depend on only one claim, the disclosure of possible implementations includes each dependent claim in combination with every other claim in the claim set.

No element, act, or instruction used herein should be construed as critical or essential unless explicitly described as such. Also, as used herein, the articles “a” and “an” are intended to include one or more items, and may be used interchangeably with “one or more.” Where only one item is intended, the term “one” or similar language is used. Also, as used herein, the terms “has,” “have,” “having,” “include,” “including,” or the like are intended to be open-ended terms. Further, the phrase “based on” is intended to mean “based, at least in part, on” unless explicitly stated otherwise. Furthermore, expressions such as “at least one of [A] and [B]” or “at least one of [A] or [B]” are to be understood as including only A, only B, or both A and B.

Also, in the present specification, it will be understood that when elements are “connected” or “coupled” to each other, the elements may be directly connected or coupled to each other, but may alternatively be connected or coupled to each other with an intervening element therebetween, unless specified otherwise.

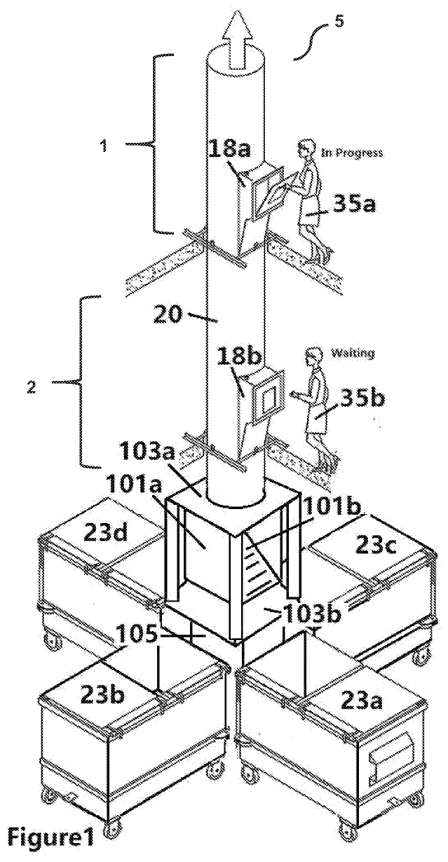

FIG. 1 shows a non-limiting embodiment comprising a gravity chute apparatus (5). As shown in FIG. 1, a first user (35a) in progress discards waste materials into a gravity chute portal, or upper branch door, (18a) on a gravity chute main body (20) connecting the upper branch (1) of the gravity chute main body (20) to the lower branch (2) of the gravity chute main body (20) via an adjustment pipe on the gravity chute main body (20). FIG. 1 also shows an optional second user (35b) in waiting while upper branch door (18a) is in use. FIG. 1 shows a lower branch door (18b) in the lower branch (2) of the gravity chute main body (20).

According to the non-limiting embodiment shown in FIG. 1, waste materials travel down the gravity chute main body (20) to a diversion area comprising a housing (101a), which comprises an angled impact diversion surface (101b) mounted in the housing (101a). FIG. 1 also shows a crown (103a) above the housing (101a).

According to one non-limiting embodiment, the angled impact diversion surface (101b) may be shaped like a plate and made of stainless steel, however, the angled impact diversion surface (101b) is not limited to these example embodiments. The angled impact diversion surface (101b) may be angled at a wide variety of different angles relative to the horizontal axis, consistent with non-limiting embodiments. The angled impact diversion surface (101b) is configured to rotate toward respective waste receptacles or bins (23a, 23b, 23c and 23d). A wide variety of different mechanisms can be used to rotate the angled impact diversion surface (101b) according to various non-limiting embodiments. As one non-limiting example, a rotational weight distribution plate may be used under the angled impact diversion surface (101b).

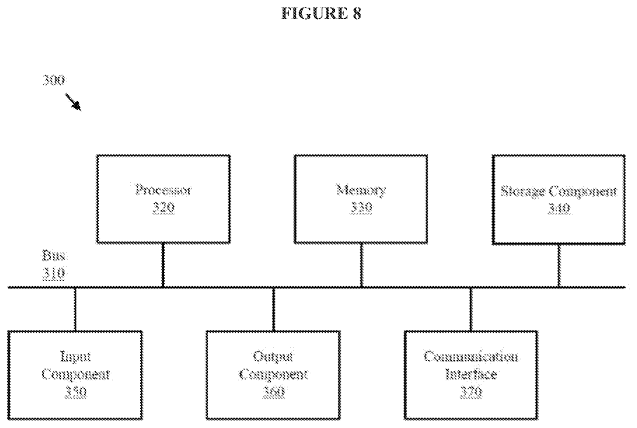

According to the non-limiting embodiment shown in FIG. 1, a series of four waste receptacles, or bins (23a, 23b, 23c and 23d) perpendicular to each other in a 90 degree array are configured to receive the discarded waste materials which travel over the lower crown guard (103b) and into one of the waste receptacles (23a, 23b, 23c and 23d) corresponding to the first user's (35a) selection on a user interface 300 (the user interface 300 is not shown in FIG. 1, but is shown in detail in FIG. 8). However, embodiments are not limited to this specific configuration and many different numbers of bins and array configurations may be employed consistent with non-limiting embodiments.

The user interface 300 may comprise one or more devices capable of receiving, generating, storing, processing, and/or providing information associated with the gravity chute apparatus (5). For example, the user interface 300 may include an electronic user interface, a circuit board, switches, a computing device (e.g., a desktop computer, a touch screen display panel, a laptop computer, a tablet computer, a handheld computer, a smart speaker, a server, etc.), a mobile phone (e.g., a smart phone, a radiotelephone, etc.), a wearable device (e.g., a pair of smart glasses or a smart watch), or a similar device. Further, according to a non-limiting embodiment multiple user interfaces may be provided, such that each one of the users, such as the first user (35a), the second user (35b), etc. may use a respective user interface.

According to the non-limiting embodiment shown in FIG. 1, waste materials may travel down a gravity chute main body (20), accelerate to the crown (103a) and impact the rotational angled impact diversion surface (101b). The waste materials may then divert off the angled impact diversion surface (101b) over the lower crown guard (103b), which sits on top of a lower diverter base (105), and travel into one of the waste receptacles (23a, 23b, 23c and 23d).

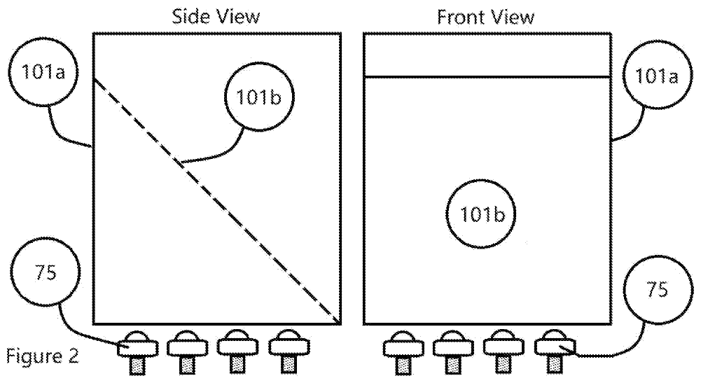

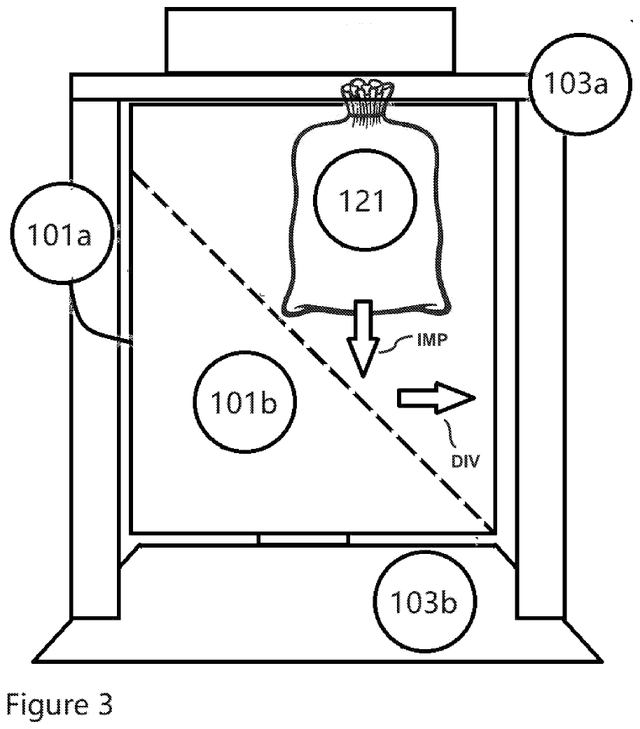

FIG. 2 shows a front view and a side view of the angled impact diversion surface (101b), according to one non-limiting embodiment. The angled impact diversion surface (101b) resides in a housing (101a), which rests on transfer bearings (75). The housing (101a) houses the angled impact diversion surface (101b). The housing (101a) and the angled impact diversion surface (101b) are both elements of a horizontal rotational waste diversion mechanism whereby impact on the angled impact diversion surface (101b) diverts discarded waste materials, as described above with reference to FIG. 1. According to one non-limiting embodiment, such discarded waste materials may include the discarded waste container (121) (shown in FIG. 3). The horizontal rotational waste diversion mechanism also diverts the Newtonian Energy of the mass of the discarded waste materials downward onto the transfer bearings (75) thereby spreading the mass velocity of the discarded waste materials over an evenly applied surface. The diversion of the discarded waste materials diverts off the angled impact diversion surface (101b) and in the direction of an opening of the housing (101a) towards one of the waste receptacles (23a, 23b, 23c and 23d) (shown in FIG. 1).

According to a non-limiting embodiment, ball transfer bearings (75) are configured to move in all directions and enable the easy transfer of loads—changing the direction of motion instantly. Each of the ball transfer bearings (75) comprise a large load-bearing ball which sits upon many smaller balls encapsulated in a semi-spherical cup. Below the cup are 16 mm threaded studs which screw into the top surface of the lower diverter base (105) (shown in FIG. 1). The energy from the angled impact diversion surface (101b) is evenly dispersed over an array of evenly spaced transfer bearing (75). However, a non-limiting embodiment is not necessarily limited to this specific configuration of transfer bearings (75) and a wide variety of different bearings may be used.

According to one non-limiting example, using the formula F=m*a, a 10 kg bag of waste traveling at 27 Meters per Second (m/s) will impact a diversion plate at 270N=˜27.5 kgf. A repetitive impact of bags of waste could cause damage to pivoting ball joints on the actuator arms and hinges, if pivoting ball joints on the actuator arms and hinges were used according to conventional devices.

However, according to a non-limiting embodiment, a stable diversion surface, such as the angled impact diversion surface (101b), when impacted, would simply absorb the impact of bags of waste and divert the waste into a respective homogeneous waste receptacle with minimal effect on the impact surface or the rotational control mechanism. This is due to, for instance, a rotational weight distribution plate sitting on evenly placed 25 mm transfer bearings 75 located under the rotational impact surface housing (101a). According to one non-limiting embodiment, the transfer bearings 75 can handle loads of up to 150 kg and, for instance, 8 transfer bearings are used to divert the impact load evenly displacing the impact energy and absorbing the impact energy to the ground through the support base. However, other non-limiting embodiments may employ other rotational control mechanisms, weight distribution mechanisms and transfer bearing numbers, loads, placements, etc.

FIG. 3 shows a non-limiting embodiment wherein the angled impact diversion surface (101b) is struck by a discarded waste container (121). As shown in FIG. 3, the housing (101a) resides between a diversion surface housing crown (103a) and a lower crown diversion surface (103b). The waste discarded waste container (121) deflects off the angled impact diversion surface (101b) and out the opening of the housing (101a), as represented by an arrow (IMP) depicting a direction of impact and an arrow (DIV) depicting a direction of diversion.

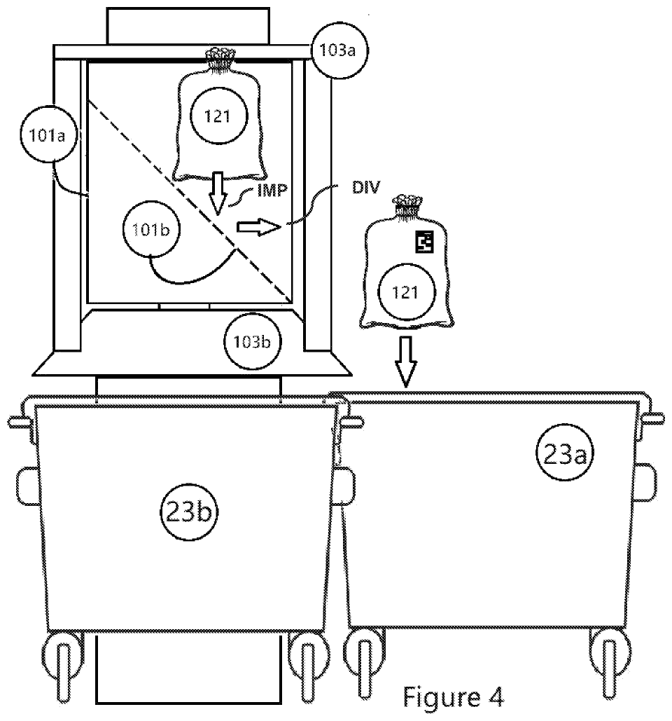

FIG. 4 shows a side view of the angled impact diversion surface (101b) diverting discarded waste container (121) into a lower waste receptacle, or “General Waste” receptacle (23a) located to the front of the diversion horizontal rotating device housing (101a). The lower waste receptacle, or “General Waste” receptacle (23a) is selected from among the waste receptacles or bins (23a, 23b, 23c and 23d) according to the waste material's genre as selected by first user (35a), as discussed above with reference to the non-limiting embodiment shown in FIG. 1. The discarded waste container (121) travels down the chute main body (20) to the base of the chute and enters the top of the crown (103a). The discarded waste container (121) passes through to impact the angled impact diversion surface (101b), thereby diverting the discarded waste container (121) in a perpendicular direction, as represented by the arrow (IMP) depicting an impact direction and the arrow (DIV) depicting a diversion direction, into one of the lower waste containers (23a, 23b). Also shown according to the non-limiting embodiment in FIG. 4 is a lower deflector component of the crown (103a), which further ensures waste materials which scatter from the impact surface are also diverted cleanly and efficiently into the waste containers (23a, 23b) below the crown skirting (103b).

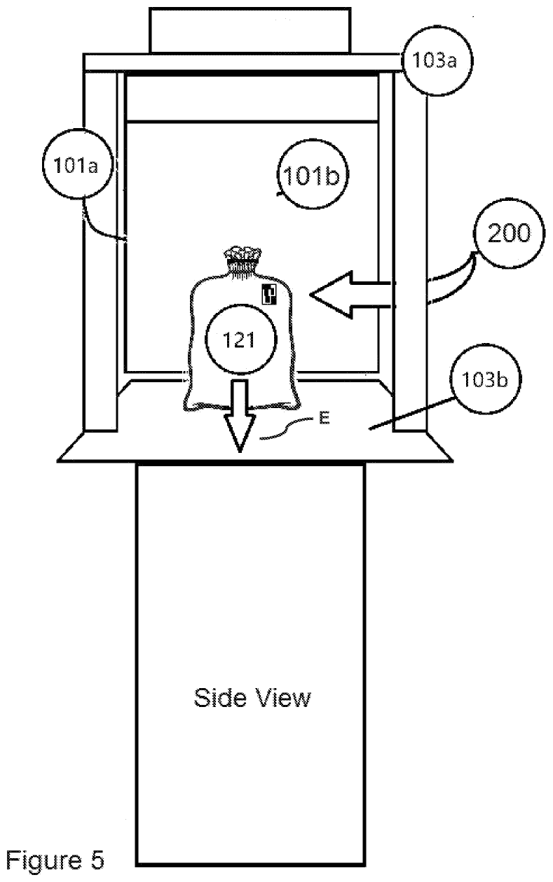

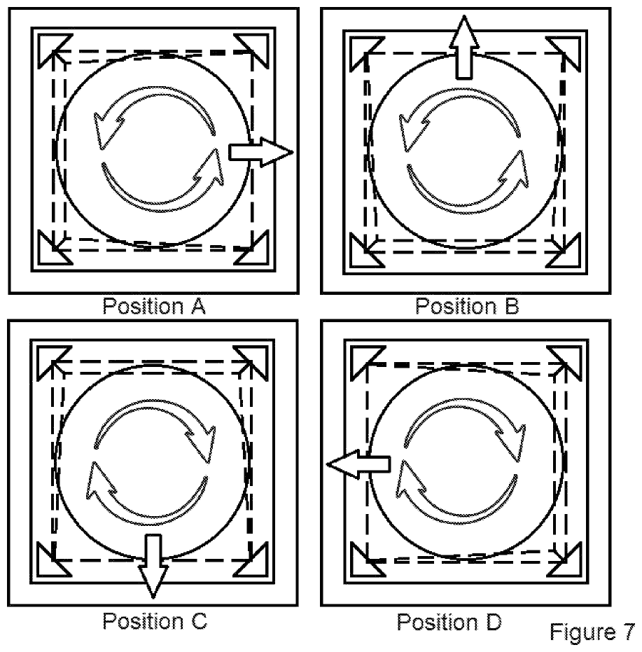

In another non-limiting embodiment, FIG. 5 shows side view with a 90 degree horizontally rotated angled impact diversion surface (101b) diverting discarded waste container (121) over the lower crown diversion shield (103b) as signified by a horizontal rotational icon (200) showing movement of the angled impact diversion surface (101b) from the position shown in FIG. 4 facing front of the housing (101a) opening. According to a non-limiting embodiment, there are four separate positions at 90 degree perpendicular positions, as shown in detail in FIG. 7. In FIG. 5, the opening of the housing (101a) is facing sideways to the right of the original “Resting Position,” known as “Home” position, which is shown in FIG. 4.

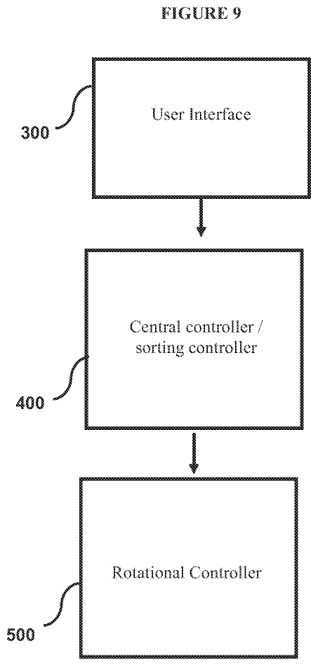

When one of the users (35a, 35b), discussed above with reference to the non-limiting embodiment shown in FIG. 1, makes a selection on the user interface 300 (shown in FIG. 8) and discards a waste container (121), as shown in FIGS. 3, 4 & 5), the user interface 300 sends a signal to an electronic control mechanism, such as a central controller or sorting controller 400 (shown in FIG. 9). The central controller or sorting controller 400 in turn sends a signal to the diverter rotational control device, such as a rotational controller 500 (also shown in FIG. 9). According to a non-limiting embodiment, the rotational controller 500 may be located in the base of the horizontally rotational diverter mechanism which horizontally rotates the angled impact diversion surface (101b) housed in the housing (101a). The energy of the waste container (121) is depicted in FIG. 5 by an arrow (E) showing a direction of the diverted waste container (121).

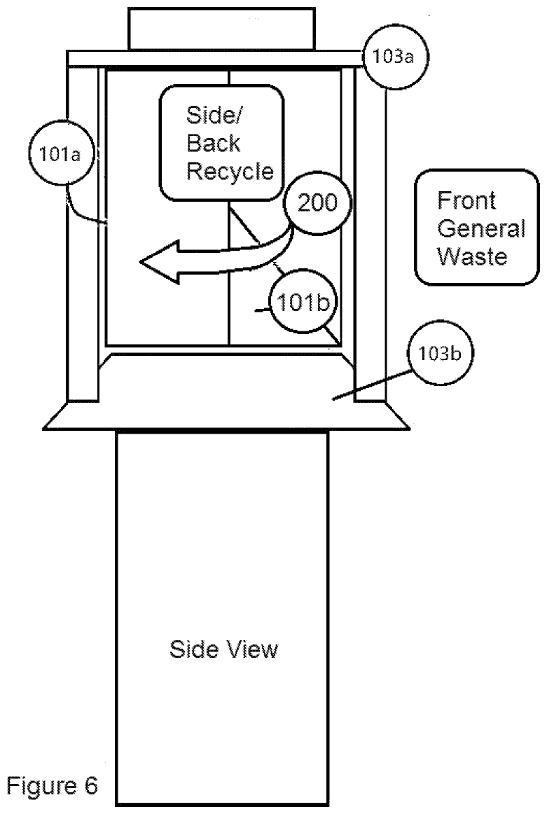

FIG. 6 shows a side view with 45 degree horizontal rotation depicting a front and a side of the angled impact diversion surface (101b), which is rotated, as shown by rotational icon (200), from the original Home position facing the front “General Waste” receptacle (23a) as shown in FIG. 4. FIG. 6 shows that the position of the housing (101a) is rotated clockwise towards the side where another waste receptacle (23b) (shown in FIG. 4) may reside. Each waste receptacle is respective to a homogeneous waste as selected by a user (35a, 35b) FIG. 1.

FIG. 7 shows a downward facing view of a rotational positional diagram, according to a non-limiting embodiment, showing different rotation positions of the angled impact diversion surface (101b), which respectively divert the discarded waste container (121) into four different positions (Position A, Position B, Position C & Position D) of waste receptacles (23a, 23b, 23c & 23d). As shown in FIG. 7, the Position A (zero degrees) may be assigned as the “Home Position,” whereby the diverter is at rest and points to Front position where the “General Waste” receptacle (23a) (shown in FIGS. 3, 4, 5 & 6) physically resides. When a user (35a, 35b) makes a selection, the housing (101a) is rotated by an electro-mechanical device in the direction corresponding to the user's (35a, 35b) selection on the electronic user interface 300 (shown in FIG. 8).

According to the non-limiting embodiment shown in FIG. 7, the rotation positions Position B, Position C and Position D, are rotated relative to Position A by increments of 90 degrees. For instance, a selection of one of the waste receptacles (23a, 23b, 23c & 23d) used for Paper may correspond to a right rotation, Position C, which is 90 degrees from the Home Position (Position A is at 0 degrees). Likewise, one of the waste receptacles (23a, 23b, 23c & 23d) used for Plastic, Metal and Glass may correspond to a left rotation, Position B, which is 270 degrees from the Home Position (Position A). Further, one of the waste receptacles (23a, 23b, 23c & 23d) for Organic waste may correspond to a right rotation, Position D, which is 180 degrees from the Home Position (Position A). However, non-limiting embodiments are not limited to the specific configuration shown in FIG. 7 and a wide variety of positions and rotational increments may be used. For instance, as another non-limiting embodiment, the number of discarded waste collecting receptacles may be changed from four bins to eight bins, and the rotational increments may be correspondingly changed from 90 degrees to 45 degrees.

FIG. 8 shows a block diagram of example components of a user interface 300, according to a non-limiting embodiment. As shown in FIG. 8, the user interface 300 may include a bus 310, a processor 320, a memory 330, a storage component 340, an input component 350, an output component 360, and a communication interface 370.

Bus 310 includes a component that permits communication among the components of user interface 300. Processor 320 may be implemented in hardware, firmware, or a combination of hardware and software. Processor 320 may be a central processing unit (CPU), a graphics processing unit (GPU), an accelerated processing unit (APU), a microprocessor, a microcontroller, a digital signal processor (DSP), a field-programmable gate array (FPGA), an application-specific integrated circuit (ASIC), or another type of processing component. In some implementations, processor 320 includes one or more processors capable of being programmed to perform a function. Memory 330 includes a random access memory (RAM), a read only memory (ROM), and/or another type of dynamic or static storage user interface (e.g., a flash memory, a magnetic memory, and/or an optical memory) that stores information and/or instructions for use by processor 320.

Storage component 340 stores information and/or software related to the operation and use of user interface 300. For example, storage component 340 may include a hard disk (e.g., a magnetic disk, an optical disk, a magneto-optic disk, and/or a solid state disk), a compact disc (CD), a digital versatile disc (DVD), a floppy disk, a cartridge, a magnetic tape, and/or another type of non-transitory computer-readable medium, along with a corresponding drive. Input component 350 includes a component that permits user interface 300 to receive information, such as via user input (e.g., a touch screen display, a keyboard, a keypad, a mouse, a button, a switch, and/or a microphone). Additionally, or alternatively, input component 350 may include a sensor for sensing information (e.g., a global positioning system (GPS) component, an accelerometer, a gyroscope, and/or an actuator). Output component 360 includes a component that provides output information from user interface 300 (e.g., a display, a speaker, and/or one or more light-emitting diodes (LEDs)).

Communication interface 370 includes a transceiver-like component (e.g., a transceiver and/or a separate receiver and transmitter) that enables user interface 300 to communicate with other devices, such as via a wired connection, a wireless connection, or a combination of wired and wireless connections. Communication interface 370 may permit user interface 300 to receive information from another device and/or provide information to another device. For example, communication interface 370 may include an Ethernet interface, an optical interface, a coaxial interface, an infrared interface, a radio frequency (RF) interface, a universal serial bus (USB) interface, a Wi-Fi interface, a cellular network interface, or the like.

User interface 300 may perform one or more processes described herein. User interface 300 may perform these processes in response to processor 320 executing software instructions stored by a non-transitory computer-readable medium, such as memory 330 and/or storage component 340. A computer-readable medium is defined herein as a non-transitory memory device. A memory device includes memory space within a single physical storage device or memory space spread across multiple physical storage devices.

Software instructions may be read into memory 330 and/or storage component 340 from another computer-readable medium or from another device via communication interface 370. When executed, software instructions stored in memory 330 and/or storage component 340 may cause processor 320 to perform one or more processes described herein.

Additionally, or alternatively, hardwired circuitry may be used in place of or in combination with software instructions to perform one or more processes described herein. Thus, implementations described herein are not limited to any specific combination of hardware circuitry and software.

The number and arrangement of components shown in FIG. 8 are provided as an example. In practice, the user interface 300 may include additional components, fewer components, different components, or differently arranged components than those shown in FIG. 8. Additionally, or alternatively, a set of components (e.g., one or more components) of user interface 300 may perform one or more functions described as being performed by another set of components of user interface 300.

FIG. 9 is a block diagram showing a user interface 300, central controller/sorting controller 400 and a rotational controller 500 according to a non-limiting embodiment. According to various non-limiting embodiments, the user interface 300, central controller/sorting controller 400, and rotational controller 500 may be configured to communicate with each other in a wide variety of ways, including, but not-limited to, via a wired connection, a wireless connection, or a combination of wired and wireless connections.

The user interface 300 has been described in detail above. According to a non-limiting embodiment, the central controller/sorting controller 400 may be implemented by at least one processor (not shown), which may be implemented in hardware, firmware, or a combination of hardware and software. The at least one processor of the central controller/sorting controller 400 may be a central processing unit (CPU), a graphics processing unit (GPU), an accelerated processing unit (APU), a microprocessor, a microcontroller, a digital signal processor (DSP), a field-programmable gate array (FPGA), an application-specific integrated circuit (ASIC), or another type of processing component.

According to a non-limiting embodiment, the central controller/sorting controller 400 may be configured to transmit and/or receive information to/from the user interface 300, including, but not limited to, information about a user selection. The central controller/sorting controller 400 may also be configured to transmit and/or receive information to/from the rotational controller 500, including, but not limited to, information about a user selection. According to a non-limiting embodiment, the rotational controller 500 may be configured to control the rotation mechanism for rotating the angled impact diversion surface (101b) to the rotational position corresponding to the user's selection (e.g., Position A, Position B, Position C and Position D, as described above).

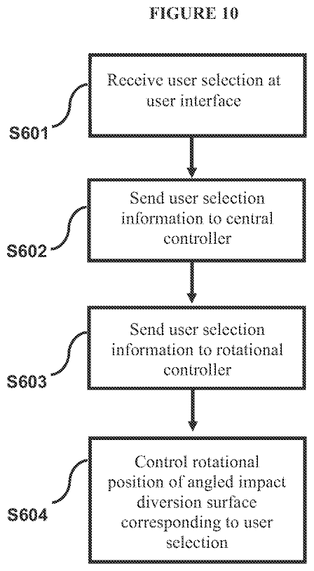

FIG. 10 is a flow chart showing a method of horizontal rotational separation of waste according to a non-limiting embodiment. As shown in FIG. 10, operation S601 may comprise receiving a user selection at the user interface 300. In operation S602, user selection information is sent from the user interface 300 to the central controller/sorting controller 400. In operation S603, user selection information is sent from the central controller/sorting controller 400 to the rotational controller 500. Finally, in operation S604, the rotational controller 500 controls the rotational position of the angled impact diversion surface (101b) corresponding to the user's selection.

As one non-limiting example, the discarded waste container (121) may include paper that is to be recycled and one of the users (35a, 35b) may make a selection relating to paper, which is received at the user interface 300 (operation S601). The user interface 300 may then send user selection information to the central controller/sorting controller 400 (operation S602). The central controller/sorting controller 400 may then send user selection information to the rotational controller 500 (operation S603). Finally, the rotational controller 500 may control rotation of the angled impact diversion surface (101b) corresponding to the user's selection (relating to paper) (operation S604). In such a way, the angled impact diversion surface (101b) may be controlled to rotate to Position C and, consequently, the discarded waste container (121) including paper may be diverted to the one of the waste receptacles (23a, 23b, 23c & 23d) used for Paper.

According to one or more non-limiting embodiments, the angled impact diversion surface (101b) may comprise an electromechanical horizontally rotational hardened impact surface housed in a horizontal rotational housing used in homogeneous and heterogeneous waste dispensary to separate waste into respective genre's waste collection containers for the purpose of recycling.

According to one or more non-limiting embodiments, an electromechanical element such as a motor, a stepper motor, a hydraulic motor, a DC gear drive motor, a frequency drive motor, or the like may be controlled by the rotational controller 500 to electromechanically rotate the housing (101a). Further, according to one or more non-limiting embodiments, such an electromechanical element may incrementally rotate a horizontal impact surface housing containing a hardened surface angled impact plate for the purpose of diverting recyclable waste materials.

According to one or more non-limiting embodiments, the horizontal impact housing may reside on a poly-directional transfer anti-friction element to evenly disperse impact energy acted upon the horizontally rotating impact surface onto a diverter base which absorbs the energy by deflecting it to a floor surface.

The foregoing disclosure provides illustration and description, but is not intended to be exhaustive or to limit the implementations to the precise form disclosed. Modifications and variations are possible in light of the above disclosure or may be acquired from practice of the implementations.

It will be apparent that systems and/or methods, described herein, may be implemented in different forms of hardware, firmware, or a combination of hardware and software. The actual specialized control hardware or software code used to implement these systems and/or methods is not limiting of the implementations. Thus, the operation and behavior of the systems and/or methods were described herein without reference to specific software code—it being understood that software and hardware may be designed to implement the systems and/or methods based on the description herein.

Embodiments of the disclosure have been shown and described above, however, the embodiments of the disclosure are not limited to the aforementioned specific embodiments. It may be understood that various modifications, substitutions, and improvements can be made by those having ordinary skill in the art in the technical field to which the disclosure belongs, without departing from the spirit of the disclosure as claimed by the appended claims. It should be understood that such modifications, substitutions, and improvements shall fall within the protection scope of the disclosure, and should not to be construed independently from the technical idea or prospect of the disclosure.

We claim:

1. An apparatus comprising:
an impact diversion surface;
an electromechanically rotatable housing which houses the impact diversion surface;
at least one controller configured to receive information about a user's input identifying one of waste receptacles,
wherein the housing comprises an opening,
wherein the impact diversion surface is configured to receive impact of waste that has fallen through the opening and divert the received waste in a diversion direction,
wherein the impact diversion surface is configured to rotate with rotation of the housing, and
wherein the at least one controller is configured to control rotation of the housing and the impact diversion surface in accordance with the received information about the user's input so that the diversion direction is toward the identified one of the waste receptacles.

2. The apparatus of claim 1, wherein each one of the waste receptacles is configured for a different type of waste.

3. The apparatus of claim 1, further comprising a stepper motor configured to be controlled by the at least one controller to electromechanically rotate the housing.

4. The apparatus of claim 3, wherein the stepper motor is configured to incrementally rotate the housing.

5. The apparatus of claim 1, wherein the impact diversion surface is configured to receive the impact of the waste in an impact direction, and
wherein the impact diversion surface is configured to intersect, and be non-perpendicular to, the impact direction.

6. The apparatus of claim 1, wherein the impact diversion surface is a surface of a plate.

7. The apparatus of claim 1, further comprising a transfer surface which supports the housing,
wherein the transfer surface is configured to evenly disperse impact energy onto a diverter base,
wherein the diverter base is configured to divert the impact energy to a floor surface, and
where the impact energy results from the received impact of waste on the impact diversion surface.

8. The apparatus of claim 1, further comprising a hydraulic motor configured to be controlled by the at least one controller to electromechanically rotate the housing.

9. The apparatus of claim 8, wherein the hydraulic motor is configured to incrementally rotate the housing.

10. The apparatus of claim 1, further comprising a DC gear drive motor configured to be controlled by the at least one controller to electromechanically rotate the housing.

11. The apparatus of claim 10, wherein the DC gear drive motor is configured to incrementally rotate the housing using a positioning counter wheel to determine rotation angles of the housing.

12. The apparatus of claim 1, further comprising a frequency drive motor configured to be controlled by the at least one controller to electromechanically rotate the housing.

13. The apparatus of claim 8, wherein the frequency drive motor is configured to incrementally rotate the housing.

14. The apparatus of claim 1, further comprising a user interface configured to receive the user's input.

15. The apparatus of claim 1, wherein the at least one controller is configured to control rotation of the housing and the impact diversion surface so that the diversion direction may be toward any one of the waste receptacles.

16. An apparatus comprising:
an impact diversion means;
an electromechanically rotatable housing means for housing the impact diversion means;
a control means for receiving information about a user's input identifying one of plural waste receiving means,
wherein the housing means comprises an opening,
wherein the impact diversion means is for receiving impact of waste that has fallen through the opening in an impact direction and diverting the received waste in a diversion direction,
wherein the impact diversion means is for rotating with rotation of the housing means, and
wherein the a control means is for controlling rotation of the housing means and the impact diversion means in accordance with the received information about the user's input so that the diversion direction is toward the identified one of the plural waste receiving means.

17. A method comprising:
receiving, by at least one controller, information about a user's input identifying one of waste receptacles;
controlling, by the at least one controller, rotation of an electromechanically rotatable housing, which houses an impact diversion surface, which rotates with the rotation of the housing, in accordance with the received information about the user's input, so that a diversion direction of the impact diversion surface is toward the identified one of the waste receptacles,
wherein the diversion direction is a direction toward which the impact diversion surface diverts waste that impacts the impact diversion surface after falling through an opening of the housing.
